(19) United States
(12) Patent Application Publication
(10) Pub. No.: US 2025/0020983 A1
(43) Pub. Date: Jan. 16, 2025

(54) WAVELENGTH CONVERSION ELEMENT, PROJECTION DEVICE, AND MANUFACTURING METHOD OF WAVELENGTH CONVERSION ELEMENT

(71) Applicant: Coretronic Corporation, Hsin-Chu (TW)

(72) Inventor: Kuo-Chou Chang, Hsin-Chu (TW)

(73) Assignee: Coretronic Corporation, Hsin-Chu (TW)

(21) Appl. No.: 18/752,800

(22) Filed: Jun. 25, 2024

(30) Foreign Application Priority Data
Jul. 13, 2023 (CN) 202310856285.8

(51) Int. Cl. G03B 21/20; C03C 4/12; C03C 14/00; G03B 33/12

(52) U.S. Cl. CPC G03B 21/204; C03C 4/12; C03C 14/006; G03B 33/12; C03C 2203/10; C03C 2203/52; C03C 2214/04

(57) ABSTRACT

A wavelength conversion element includes a substrate and a wavelength conversion material, wherein the wavelength conversion material is disposed on the substrate, and the wavelength conversion material is configured to convert an excitation beam into a conversion beam. The wavelength conversion material includes a fluorescent glass and a second fluorescent material. The fluorescent glass includes a glass material and a first fluorescent material. The fluorescent glass covers the second fluorescent material, and the first fluorescent material and the second fluorescent material are different.

### CROSS-REFERENCE TO RELATED APPLICATION

This application claims the priority benefit of China application serial no. 202310856285.8 filed on Jul. 13, 2023. The entirety of the above-mentioned patent application is hereby incorporated by reference herein and made a part of this specification.

### BACKGROUND OF THE INVENTION

### Field of the Invention

The invention relates to an optical element, an electronic device, and a manufacturing method of an optical element, and in particular to a wavelength conversion element, a projection device, and a manufacturing method of a wavelength conversion element.

### Description of Related Art

A projection device is a display device used to generate large-scale images, and is constantly improving with the evolution and innovation of science and technology. The imaging principle of the projection device is to convert an illumination beam generated by an illumination system into an image beam via a light valve, and then project the image beam on a projection target (such as a screen or a wall) via a projection lens to form a projection image. In addition, the illumination system uses an excitation beam to excite a fluorescent layer on a fluorescent color wheel to obtain beams of different colors. Generally, the fluorescent layer is made of glass as a material, and is formed by mixing crushed glass powder with phosphor and then sintering the two together. In particular, the excitation beam incident on the fluorescent color wheel excites the phosphor to obtain fluorescence, and the wavelength of the fluorescence depends on the added phosphor. However, glass only serves as a binding agent in the fluorescent layer and may not be excited to produce fluorescence. In other words, the luminous efficiency and fluorescent wavelength of the fluorescent color wheel are only limited by the phosphor itself, and the glass does not have light-emitting function.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY OF THE INVENTION

The invention provides a wavelength conversion element, a projection device, and a manufacturing method of a wavelength conversion element that may improve luminous efficiency and may also achieve the effect of adjusting the color coordinate of the beam via different fluorescent materials.

Other objects and advantages of the invention may be further understood from the technical features disclosed in the invention.

To achieve one or part or all of the above objects or other objects, the invention provides a wavelength conversion element including a substrate and a wavelength conversion material, wherein the wavelength conversion material is disposed on the substrate, and the wavelength conversion material is configured to convert an excitation beam into a conversion beam. The wavelength conversion material includes a fluorescent glass and a second fluorescent material. The fluorescent glass includes a glass material and a first fluorescent material. The fluorescent glass covers the second fluorescent material, and the first fluorescent material and the second fluorescent material are different.

In an embodiment of the invention, the conversion beam has a plurality of different wavelength peaks.

In an embodiment of the invention, the fluorescent glass is configured to convert the excitation beam into a first beam, the second fluorescent material is configured to convert the excitation beam into a second beam, a wavelength peak of the first beam and a wavelength peak of the second beam are different, and the conversion beam comprises at least one of the first beam and the second beam.

In an embodiment of the invention, a wavelength peak of the first beam is greater than a wavelength peak of the second beam.

In an embodiment of the invention, a wavelength peak of the first beam is less than a wavelength peak of the second beam.

In an embodiment of the invention, the glass material includes silicate, borate, aluminate, phosphate, alkali metal, alkaline earth metal, zinc oxide, or any combination thereof.

In an embodiment of the invention, a thickness of the wavelength conversion material is between 0.05 mm and 0.5 mm.

In an embodiment of the invention, the first fluorescent material includes gadolinium, terbium, gallium, manganese or any combination thereof.

In an embodiment of the invention, the second fluorescent material includes cerium-doped yttrium aluminum garnet, cerium-doped lutetium aluminum garnet, or a combination thereof.

In an embodiment of the invention, a weight percentage concentration of the fluorescent glass in the wavelength conversion material is between 40% and 70%.

In an embodiment of the invention, a weight percentage concentration of the first fluorescent material in the fluorescent glass is less than or equal to 10%.

In an embodiment of the invention, a weight percentage concentration of the first fluorescent material in the wavelength conversion material is less than or equal to 10%.

In an embodiment of the invention, a weight percentage concentration of the second fluorescent material in the wavelength conversion material is between 30% and 60%.

In an embodiment of the invention, the substrate has a wavelength conversion region and a non-wavelength conversion region, and the wavelength conversion material is disposed at the wavelength conversion region.

To achieve one or part or all of the above objects or other objects, the invention provides a projection device including an illumination system, a light valve, and a projection lens. The illumination system is configured to provide an illumination beam, and the illumination system includes a light source module and a wavelength conversion element. The light source module is configured to provide an excitation beam. The wavelength conversion element is disposed on a transmission path of the excitation beam. A wavelength conversion element includes a substrate and a wavelength conversion material, wherein the wavelength conversion material is disposed on the substrate, and the wavelength conversion material is configured to convert the excitation beam into a conversion beam. The wavelength conversion material includes a fluorescent glass and a second fluorescent material. The fluorescent glass includes a glass material and a first fluorescent material. The fluorescent glass covers the second fluorescent material, and the first fluorescent material and the second fluorescent material are different. The illumination beam includes at least one of the excitation beam and the conversion beam. The light valve is disposed on a transmission path of the illumination beam and configured to convert the illumination beam into the image beam. The projection lens is disposed on a transmission path of the image beam and configured to project the image beam out of the projection device.

In order to achieve one, part, or all of the above objects or other objects, the invention provides a manufacturing method of a wavelength conversion element including a step of mixing a glass material and a first fluorescent material to form a fluorescent glass body raw material; a step of manufacturing a fluorescent glass from the fluorescent glass body raw material; a step of mixing a second fluorescent material and the fluorescent glass and sintering the two to form a wavelength conversion material, wherein the first fluorescent material and the second fluorescent material are different; and a step of disposing the wavelength conversion material to a substrate to form the wavelength conversion element.

In an embodiment of the invention, the step of manufacturing the fluorescent glass from the fluorescent glass raw material further includes: heating the fluorescent glass body raw material to form a fluorescent glass body liquid; and cooling the fluorescent glass body liquid to form the fluorescent glass.

In an embodiment of the invention, a temperature of heating the fluorescent glass body raw material to form the fluorescent glass body liquid is between 1200 degrees and 1600 degrees.

In an embodiment of the invention, a viscosity of the fluorescent glass body liquid is 1 Pa·s.

In an embodiment of the invention, the step of mixing the second fluorescent material and the fluorescent glass and sintering the two to form the wavelength conversion material further includes: grinding the fluorescent glass to form a fluorescent glass powder; and mixing the second fluorescent material and the fluorescent glass powder and heating and sintering the two to form the wavelength conversion material.

In an embodiment of the invention, a sintering temperature of sintering the second fluorescent material and the fluorescent glass to form the wavelength conversion material is between 700 degrees and 900 degrees.

In an embodiment of the invention, a viscosity of the wavelength conversion material is between 10² Pa·s and 10^{5.5} Pa·s.

In an embodiment of the invention, a temperature of forming the fluorescent glass is greater than a sintering temperature of sintering the second fluorescent material and the fluorescent glass to form the wavelength conversion material.

Based on the above, the embodiments of the invention have at least one of the following advantages or functions. In the wavelength conversion element, the projection device, and the manufacturing method of the wavelength conversion element of the invention, the wavelength conversion element includes the substrate and the wavelength conversion material, and the wavelength conversion element is disposed on the transmission path of the excitation beam. In particular, the wavelength conversion material includes the fluorescent glass and the second fluorescent material, and the fluorescent glass includes the glass material and the first fluorescent material. In particular, the first fluorescent material and the second fluorescent material are different. In this way, the wavelength conversion material may achieve a composite luminous effect, improve the luminous efficiency of the wavelength conversion material, and may also achieve the effect of adjusting the color coordinate of the beam by using the wavelength difference of the beams generated by the excitation of two different fluorescent materials.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a projection device of an embodiment of the invention.

FIG. 2 is a schematic diagram of a wavelength conversion element of an embodiment of the invention.

FIG. 3 is a partial cross-sectional schematic diagram of the wavelength conversion element of FIG. 2.

FIG. 4A to FIG. 4C are respectively schematic spectral diagrams of fluorescent glass of different embodiments of the invention.

FIG. 5A and FIG. 5B are respectively schematic spectral diagrams of the second fluorescent materials of different embodiments of the invention.

FIG. 6 is a schematic spectral diagram of a wavelength conversion material of an embodiment of the invention.

FIG. 7 is a flowchart of steps of a manufacturing method of a wavelength conversion element of an embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

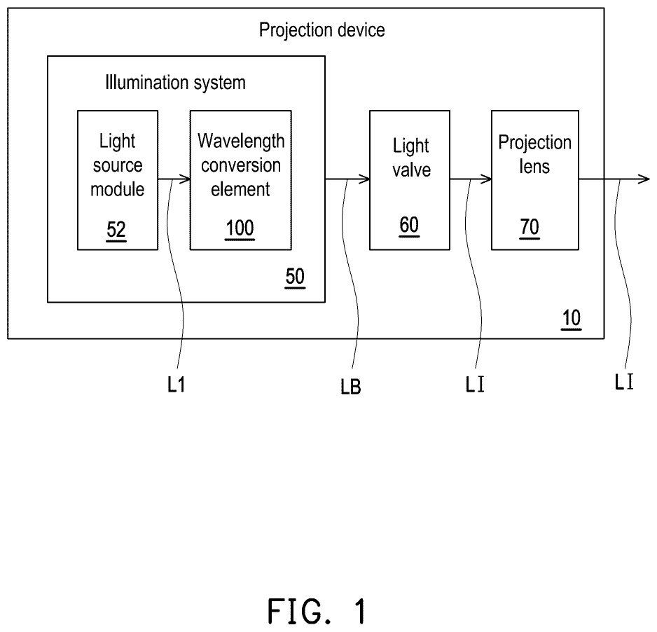

FIG. 1 is a schematic diagram of a projection device of an embodiment of the invention. Please refer to FIG. 1. The present embodiment provides a projection device (projector) 10 including an illumination system 50, light valve 60, and a projection lens 70. In particular, the illumination system 50 is configured to provide an illumination beam LB. The light valve 60 is disposed on the transmission path of the illumination beam LB and configured to convert the illumination beam LB into an image beam LI. The projection lens 70 is disposed on the transmission path of the image beam LI, and is configured to project the image beam LI out of the projection device 10 to a projection target (not shown), such as a screen or a wall.

The illumination system 50 is configured to provide the illumination beam LB. For example, in the present embodiment, the illumination system 50 comprises, for example, a light source module 52, a wavelength conversion element 100, a light homogenizing element, a light filter element, and a plurality of light splitting and combining elements, and is configured to provide light having different wavelengths as the source of the illumination beam LB. The light source module 52 is formed by a plurality of light-emitting elements, for example, and is configured to provide the excitation beam L1. The light-emitting element is, for example, a light-emitting diode (LED) or a laser diode (LD). The wavelength conversion element 100 is, for example, a fluorescent color wheel disposed on the transmission path of the excitation beam L1 and configured to convert the excitation beam L1 into the conversion beam L2. The conversion beam L2 is, for example, fluorescent light. The illumination beam LB includes at least one of the excitation beam L1 and the conversion beam L2. However, the invention does not limit the type or form of the illumination system 50 in the projection device 10, and sufficient teaching, suggestion, and implementation of the detailed structure and embodiments thereof may be obtained from common knowledge in the art, which are therefore not repeated herein.

The light valve 60 is, for example, a reflective light modulator such as a liquid crystal on silicon panel (LCoS panel) or a digital micro-mirror device (DMD). In some embodiments, the light valve 60 may also be a transmissive light modulator such as a transparent liquid-crystal panel, an electro-optical modulator, a magneto-optic modulator, or an acousto-optic modulator (AOM). The invention does not limit the configuration and the type of the light valve 60. Regarding the method in which the light valve 60 converts the illumination beam LB into the image beam LI, sufficient teaching, suggestion, and implementation of the detailed steps and embodiments thereof may be obtained from common knowledge in the art, which are therefore not repeated herein. In the present embodiment, the number of the light valve 60 is one, for example, the projection device 10 adopting a single digital micromirror element, but in other embodiments, there may be more than one, and the invention is not limited thereto.

The projection lens 70 includes, for example, a combination of one or a plurality of optical lenses having a diopter, such as including, for example, various combinations of a non-planar lens such as a biconcave lens, a lenticular lens, a convex-concave lens, a convex-concave lens, a plano-convex lens, a plano-concave lens, and the like. In an embodiment, the projection lens 70 may also include a flat optical lens projecting the image beam LI from the light valve 60 to the projection target in a reflective manner. The invention does not limit the configuration and the type of the projection lens 70.

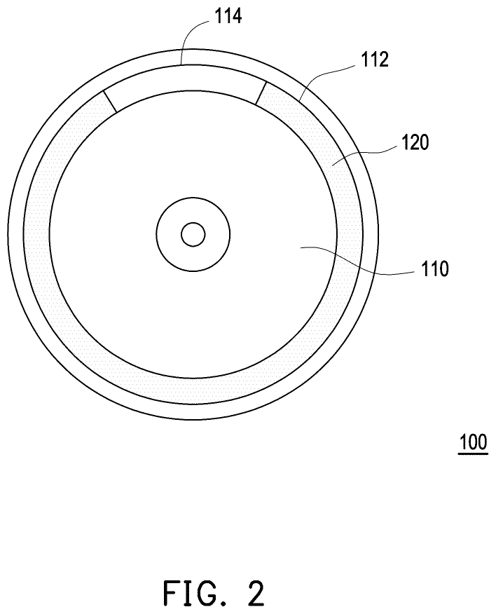

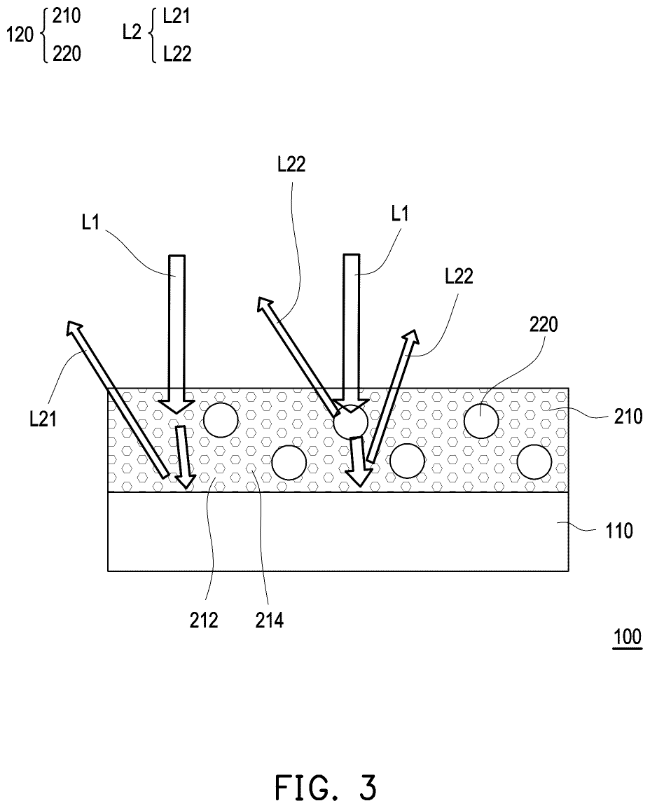

FIG. 2 is a schematic diagram of a wavelength conversion element of an embodiment of the invention. FIG. 3 is a partial cross-sectional schematic diagram of the wavelength conversion element of FIG. 2. Please refer to FIG. 1 to FIG. 3. The wavelength conversion element 100 shown in FIG. 2 may be applied to at least the projection device 10 shown in FIG. 1. The wavelength conversion element 100 includes a substrate 110 and a wavelength conversion material 120. The wavelength conversion material 120 is disposed on the substrate 110 and configured to convert the excitation beam L1 into the conversion beam L2. The substrate 110 may be a reflective substrate or a translucent substrate, and the surface of the substrate 110 may be designed to have a surface with reflective properties or a translucent surface. Specifically, the substrate 110 has a wavelength conversion region 112 and a non-wavelength conversion region 114. The wavelength conversion material 120 is disposed at the wavelength conversion region 112. The non-wavelength conversion region 114 may be provided with a reflective mirror or a light-transmitting optical element. The light-transmitting optical element is, for example, a light-transmitting plate or glass. The wavelength conversion material 120 is, for example, phosphor in glass (PIG), including a fluorescent glass 210 and a second fluorescent material 220. In other embodiments, the wavelength conversion element 100 may further include a reflective layer disposed between the wavelength conversion material 120 and the substrate 110.

In detail, the fluorescent glass 210 includes a glass material 212 and a first fluorescent material 214, and the fluorescent glass 210 covers the second fluorescent material 220. The first fluorescent material 214 and the second fluorescent material 220 are different. In other words, in the present embodiment, the first fluorescent material 214 is mixed with the glass material 212 to form the fluorescent glass 210, and then the fluorescent glass 210 is sintered with the second fluorescent material 220 to form a PIG (the wavelength conversion material 120). Therefore, the conversion beam L2 generated by the wavelength conversion material 120 has a plurality of different wavelength peaks. As a result, the wavelength conversion material 120 may achieve a composite luminous effect. The fluorescent glass 210 having a larger volume also has a light-emitting function in addition to being a binding agent. In this way, the luminous efficiency of the wavelength conversion material 120 may be improved, and the effect of adjusting the color coordinate of the beam may be achieved by the wavelength difference of the beams generated by exciting two different fluorescent materials.

In the present embodiment, the weight percentage concentration of the first fluorescent material 214 in the wavelength conversion material 120 is less than or equal to 10%, thus achieving better optical effects. In a preferred embodiment, the weight percentage concentration of the first fluorescent material 214 in the wavelength conversion material 120 is between 4% and 7%. In a more preferred embodiment, the weight percentage concentration of the first fluorescent material 214 in the wavelength conversion material 120 is between 5% and 6%. Furthermore, the weight percentage concentration of the first fluorescent material 214 in the fluorescent glass 210 is less than or equal to 10%, thus achieving better optical effects. Moreover, the weight percentage concentration of the second fluorescent material 220 in the wavelength conversion material 120 is between 30% and 60%, thus achieving better optical effects. In a preferred embodiment, the weight percentage concentration of the second fluorescent material 220 in the wavelength conversion material 120 is between 40% and 50%. The weight percentage concentration of the fluorescent glass 210 in the wavelength conversion material 120 is between 40% and 70%, thus achieving better optical effects. In a preferred embodiment, the weight percentage concentration of the fluorescent glass 210 in the wavelength conversion material 120 is between 50% and 60%. In addition, the thickness of the wavelength conversion material 120 is between 0.05 mm and 0.5 mm, thus achieving better optical effects.

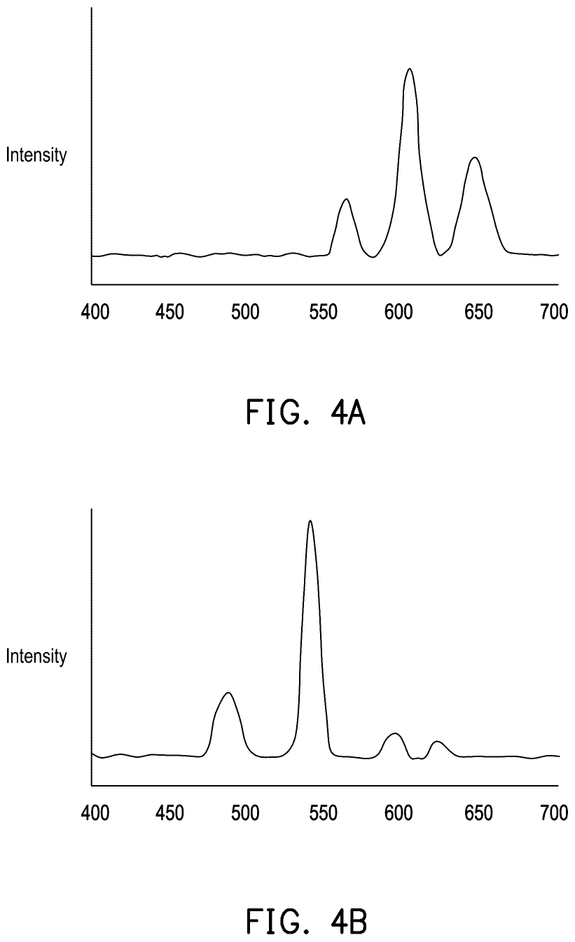

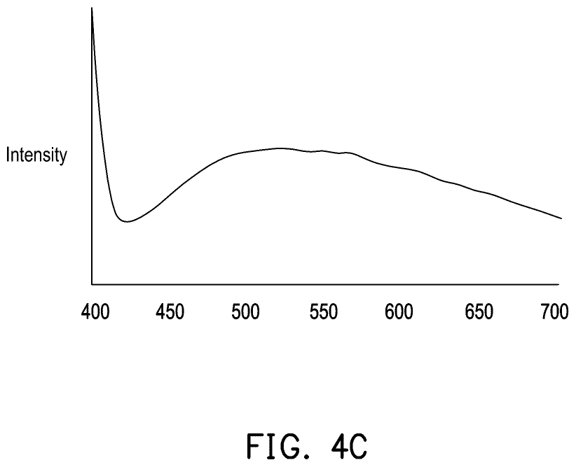

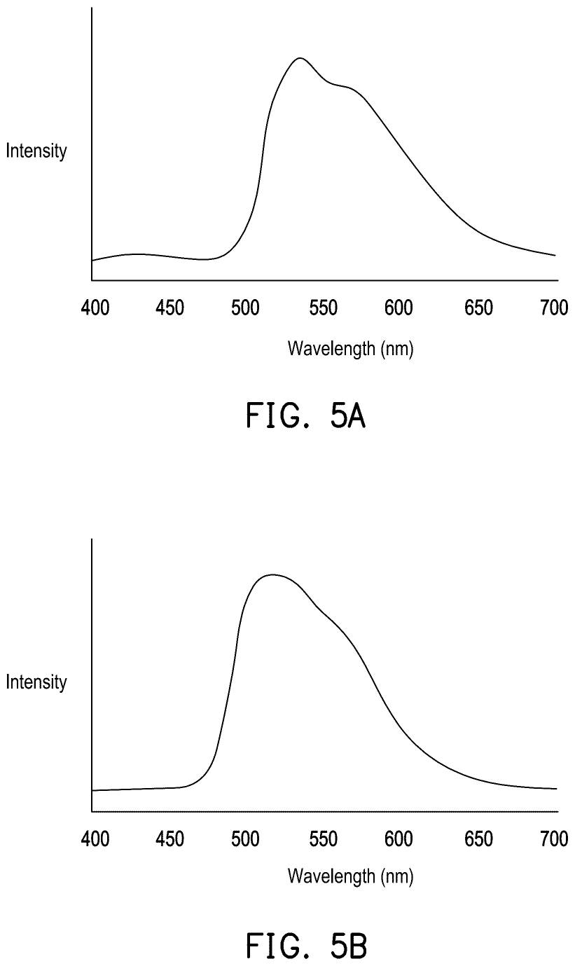

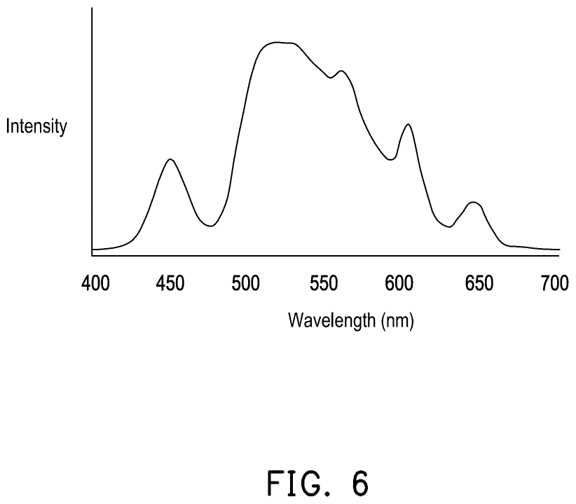

FIG. 4A to FIG. 4C are respectively schematic spectral diagrams of fluorescent glass of different embodiments of the invention. FIG. 5A and FIG. 5B are respectively schematic spectral diagrams of the second fluorescent material of different embodiments of the invention. FIG. 6 is a schematic spectral diagram of a wavelength conversion material of an embodiment of the invention. Please refer to FIG. 3 to FIG. 6. Specifically, the fluorescent glass 210 containing the first fluorescent material 214 is configured to convert the excitation beam L1 into the first beam L21, and the second fluorescent material 220 is configured to convert the excitation beam L1 into the second beam L22. The wavelength peak of the first beam L21 and the wavelength peak of the second beam L22 are different. The conversion beam L2 includes at least one of the first beam L21 and the second beam L22. The glass material 212 includes, for example, silicate, borate, aluminate, phosphate, alkali metal, alkaline earth metal, zinc oxide, or any combination of the above. In particular, the use of alkaline earth metal, alkali metal, or zinc oxide may modify the properties of glass to reduce the sintering temperature or working temperature of the glass. The first fluorescent material 214 includes, for example, gadolinium (Gd), terbium (Tb), gallium (Ga), manganese (Mn), or any combination thereof.

In the present embodiment, the wavelength of the conversion beam L2 may be determined according to the fluorescent glass 210 and/or the second fluorescent material 220 used. For example, when the glass material 212 is selected as borosilicate glass (SiO₂—B₂O₅—R₂O), and the first fluorescent material 214 is selected as gadolinium (Gd), the fluorescent glass 210 formed by the glass material 212 and the first fluorescent material 214 is borosilicate glass containing gadolinium (SiO₂—B₂O₅—R₂O:Gd). The fluorescence spectrum thereof, that is, the light wavelength energy distribution of the first beam L21, is shown in FIG. 4A. In other embodiments, when the first fluorescent material 214 is selected as terbium (Tb), and the fluorescent glass 210 formed by the glass material 212 and the first fluorescent material 214 is borosilicate glass containing terbium (SiO₂—B₂O₅—R₂O:Tb), the fluorescence spectrum thereof, that is, the light wavelength energy distribution of the first beam L21, is shown in FIG. 4B. When the first fluorescent material 214 is selected as manganese (Mn), and the fluorescent glass 210 formed by the glass material 212 and the first fluorescent material 214 is borosilicate glass containing manganese (SiO₂—B₂O₅—R₂O:Mn), the fluorescence spectrum thereof, that is, the light wavelength energy distribution of the first beam L21, is shown in FIG. 4C.

Moreover, in the present embodiment, the second fluorescent material 220 includes, for example, cerium-doped yttrium aluminum garnet (YAG:Ce), cerium-doped lutetium aluminum garnet (LuAG:Ce), or a combination thereof. For example, when the second fluorescent material 220 is selected as cerium-doped yttrium aluminum garnet, the fluorescence spectrum thereof, that is, the light wavelength energy distribution of the second beam L22, is as shown in FIG. 5A. When the second fluorescent material 220 is selected as cerium-doped lutetium aluminum garnet, the fluorescence spectrum thereof, that is, the light wavelength energy distribution of the second beam L22, is as shown in FIG. 5B.

In the present embodiment, when the fluorescent glass 210 is borosilicate glass containing gadolinium (SiO₂—B₂O₅—R₂O:Gd) and the second fluorescent material 220 is cerium-doped yttrium aluminum garnet (YAG:Ce), the fluorescence spectrum of the wavelength conversion material 120, that is, the light wavelength energy distribution of the conversion beam L2, is shown in FIG. 6. Since the wavelength peak of the first beam L21 is greater than the wavelength peak of the second beam L22, the color coordinate (x, y) of the conversion beam L2 generated by the wavelength conversion material 120 in the CIE color space is, for example, (0.452, 0.503), which is optimized compared with the color coordinate (0.418, 0.554) of the beam generated by the conventional fluorescent layer (that is, fluorescent glass without light-emitting function) in the CIE color space, thus achieving better optical effects. Moreover, when the first fluorescent material 214 is selected from gadolinium (Gd), terbium (Tb), gallium (Ga), or any combination of the above, the wavelength peak of the first beam L21 is greater than the wavelength peak of the second beam L22. When the first fluorescent material 214 is selected as manganese (Mn), the wavelength peak of the first beam L21 is less than the wavelength peak of the second beam L22. It may therefore be known that the color coordinate of the conversion beam L2 generated by the wavelength conversion material 120 of the present embodiment may be adjusted by selecting the first fluorescent material 214 and the second fluorescent material 220.

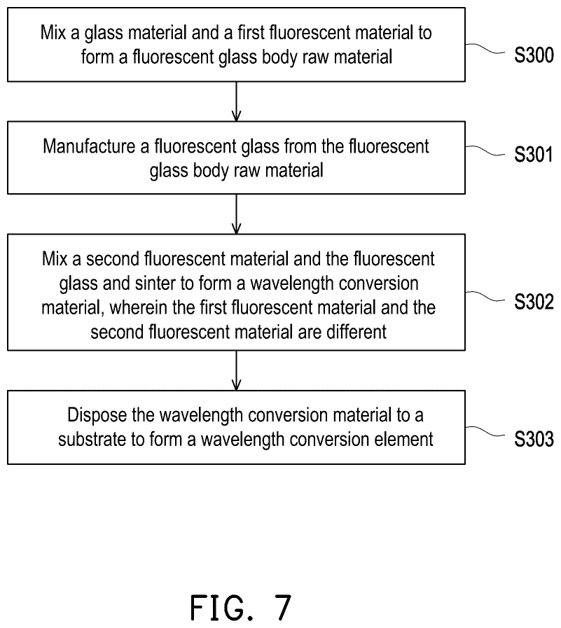

FIG. 7 is a flowchart of steps of a manufacturing method of a wavelength conversion element of an embodiment of the invention. The manufacturing method of the wavelength conversion element shown in FIG. 7 may be applied to at least the wavelength conversion element 100 shown in FIG. 3. Please refer to FIG. 3 and FIG. 7 at the same time. In the manufacturing method of the wavelength conversion element 100 of the present embodiment, step S300 is first performed to mix the glass material 212 and the first fluorescent material 214 to form a fluorescent glass body raw material. Specifically, the powdered first fluorescent material 214 is added to the powdered glass material 212, and the two are mixed to form a powdered fluorescent glass body raw material. For example, the powdered first fluorescent material 214 is added to powdered silicate, borate, and/or alkali metal. After the powdered fluorescent glass body raw material is obtained, step S301 is executed to manufacture the fluorescent glass 210 from the fluorescent glass body raw material. Specifically, in this step, the powdered fluorescent glass body raw material is first heated to form a high-temperature molten fluorescent glass body liquid. In a preferred embodiment, the temperature of heating the powdered fluorescent glass body raw material to form the fluorescent glass body liquid is between 1200 degrees and 1600 degrees, and the viscosity of the liquid fluorescent glass body liquid is 1 Pa·s (Pascal·second). In this way, the subsequently formed PIG (i.e., the wavelength conversion material 120) may have better light transmittance. Next, the molten fluorescent glass body liquid is cooled to form the fluorescent glass 210. Specifically, the molten fluorescent glass body liquid is cooled to room temperature to obtain the fluorescent glass 210 having the ability to be excited to emit the first beam (fluorescence) L21.

After the fluorescent glass 210 is obtained, step S302 is performed to mix the second fluorescent material 220 and the fluorescent glass 210 and sinter the two to form the wavelength conversion material 120, wherein the first fluorescent material 214 and the second fluorescent material 220 are different. Specifically, in this step, the fluorescent glass 210 is first ground to form fluorescent glass powder. Next, the second fluorescent material 220 and the fluorescent glass powder are mixed and then heated and sintered to form the wavelength conversion material 120. In particular, the fluorescent glass powder fills a plurality of gaps between the second fluorescent materials 220 during the sintering process. It should be noted here that the particle size of the second fluorescent material 220 is between 10 micrometers and 40 micrometers, and the first fluorescent material 214 is melted with the glass material 212 at high temperature in step S301 to form the fluorescent glass 210. Therefore, the first fluorescent material 214 in the fluorescent glass 210 is substantially uniformly mixed with the glass material 212, and the first fluorescent material 214 is not granular. In a preferred embodiment, the sintering temperature of sintering the second fluorescent material 220 and the fluorescent glass 210 to form the wavelength conversion material 120 is between 700 degrees and 900 degrees, so that the viscosity of the wavelength conversion material 120 is between 10² Pa·s and 10^{5.5} Pa·s. In a more preferred embodiment, when the sintering temperature is between 800 degrees and 850 degrees, the resulting PIG (i.e., the wavelength conversion material 120) has better light transmittance. In a preferred embodiment, the temperature of the fluorescent glass body liquid formed in step S301 is greater than the sintering temperature of sintering the second fluorescent material 220 and the fluorescent glass 210 to form the wavelength conversion material 120 in step S302.

Lastly, after the wavelength conversion material 120 is obtained, step S303 is performed to dispose the wavelength conversion material 120 to the substrate 110 to form the wavelength conversion element 100.

Based on the above, the embodiments of the invention have at least one of the following advantages or functions. In the wavelength conversion element, the projection device, and the manufacturing method of the wavelength conversion element of the invention, the wavelength conversion element includes a substrate and a wavelength conversion material, and the wavelength conversion element is disposed on the transmission path of the excitation beam. In particular, the wavelength conversion material includes the fluorescent glass and the second fluorescent material, and the fluorescent glass includes the glass material and the first fluorescent material. In particular, the first fluorescent material and the second fluorescent material are different. In this way, the wavelength conversion material may achieve a composite luminous effect, improve the luminous efficiency of the wavelength conversion material, and may also achieve the effect of adjusting the color coordinate of the beam by using the wavelength difference of the beams generated by the excitation of two different fluorescent materials.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A wavelength conversion element, comprising a substrate and a wavelength conversion material, wherein:
the wavelength conversion material is disposed on the substrate, the wavelength conversion material is configured to convert an excitation beam into a conversion beam, and the wavelength conversion material comprises:
a fluorescent glass comprising a glass material and a first fluorescent material; and
a second fluorescent material, wherein the fluorescent glass covers the second fluorescent material, and the first fluorescent material and the second fluorescent material are different.

2. The wavelength conversion element of claim 1, wherein the conversion beam has a plurality of different wavelength peaks.

3. The wavelength conversion element of claim 1, wherein the fluorescent glass is configured to convert the excitation beam into a first beam, the second fluorescent material is configured to convert the excitation beam into a second beam, a wavelength peak of the first beam and a wavelength peak of the second beam are different, and the conversion beam comprises at least one of the first beam and the second beam.

4. The wavelength conversion element of claim 3, wherein the wavelength peak of the first beam is greater than the wavelength peak of the second beam.

5. The wavelength conversion element of claim 3, wherein the wavelength peak of the first beam is less than the wavelength peak of the second beam.

6. The wavelength conversion element of claim 1, wherein the glass material comprises silicate, borate, aluminate, phosphate, alkali metal, alkaline earth metal, zinc oxide, or any combination thereof.

7. The wavelength conversion element of claim 1, wherein a thickness of the wavelength conversion material is between 0.05 mm and 0.5 mm.

8. The wavelength conversion element of claim 1, wherein the first fluorescent material comprises gadolinium, terbium, gallium, manganese, or any combination thereof.

9. The wavelength conversion element of claim 1, wherein the second fluorescent material comprises cerium-doped yttrium aluminum garnet, cerium-doped lutetium aluminum garnet, or a combination thereof.

10. The wavelength conversion element of claim 1, wherein a weight percentage concentration of the fluorescent glass in the wavelength conversion material is between 40% and 70%.

11. The wavelength conversion element of claim 1, wherein a weight percentage concentration of the first fluorescent material in the fluorescent glass is less than or equal to 10%.

12. The wavelength conversion element of claim 1, wherein a weight percentage concentration of the first fluorescent material in the wavelength conversion material is less than or equal to 10%.

13. The wavelength conversion element of claim 1, wherein a weight percentage concentration of the second fluorescent material in the wavelength conversion material is between 30% and 60%.

14. The wavelength conversion element of claim 1, wherein the substrate has a wavelength conversion region and a non-wavelength conversion region, and the wavelength conversion material is disposed at the wavelength conversion region.

15. A projection device, comprising an illumination system, a light valve, and a projection lens, wherein:
the illumination system is configured to provide an illumination beam, and the illumination system comprises a light source module and a wavelength conversion element, wherein:
the light source module is configured to provide an excitation beam; and
the wavelength conversion element is disposed on a transmission path of the excitation beam, and the wavelength conversion element comprises a substrate and a wavelength conversion material, wherein:
the wavelength conversion material is disposed on the substrate, the wavelength conversion material is configured to convert the excitation beam into a conversion beam, and the wavelength conversion material comprises a fluorescent glass and a second fluorescent material, wherein the fluorescent glass comprises a glass material and a first fluorescent material, the fluorescent glass covers the second fluorescent material, the first fluorescent material and the second fluorescent material are different, and the illumination beam comprises at least one of the excitation beam and the conversion beam;
the light valve is disposed on a transmission path of the illumination beam and configured to convert the illumination beam into an image beam; and
the projection lens is disposed on a transmission path of the image beam and configured to project the image beam out of the projection device.

16. A manufacturing method of a wavelength conversion element, comprising:
mixing a glass material and a first fluorescent material to form a fluorescent glass body raw material;
manufacturing a fluorescent glass from the fluorescent glass body raw material;
mixing a second fluorescent material and the fluorescent glass and sintering the two to form a wavelength conversion material, wherein the first fluorescent material and the second fluorescent material are different; and
disposing the wavelength conversion material to a substrate to form the wavelength conversion element.

17. The manufacturing method of the wavelength conversion element of claim 16, wherein the step of manufacturing the fluorescent glass from the fluorescent glass body raw material further comprises:
heating the fluorescent glass body raw material to form a fluorescent glass body liquid; and
cooling the fluorescent glass body liquid to form the fluorescent glass.

18. The manufacturing method of the wavelength conversion element of claim 17, wherein a temperature of heating the fluorescent glass body raw material to form the fluorescent glass body liquid is between 1200 degrees and 1600 degrees.

19. The manufacturing method of the wavelength conversion element of claim 17, wherein a viscosity of the fluorescent glass body liquid is 1 Pa·s.

20. The manufacturing method of the wavelength conversion element of claim 16, wherein the step of mixing the second fluorescent material and the fluorescent glass and sintering the two to form the wavelength conversion material further comprises:
grinding the fluorescent glass to form a fluorescent glass powder; and
mixing the second fluorescent material and the fluorescent glass powder and heating and sintering the two to form the wavelength conversion material.

21. The wavelength conversion element of claim 16, wherein a sintering temperature of sintering the second fluorescent material and the fluorescent glass to form the wavelength conversion material is between 700 degrees and 900 degrees.

22. The wavelength conversion element of claim 16, wherein a viscosity of the wavelength conversion material is between 10² Pa·s and 10^{5.5} Pa·s, and the wavelength conversion material is formed by sintering the second fluorescent material and the fluorescent glass.

23. The wavelength conversion element of claim 16, wherein a temperature of forming the fluorescent glass is greater than a sintering temperature of sintering the second fluorescent material and the fluorescent glass to form the wavelength conversion material.
